(19) United States
(12) Patent Application Publication
(10) Pub. No.: US 2024/0084919 A1
(43) Pub. Date: Mar. 14, 2024

(54) AN ACTUATOR SYSTEM FOR ACTUATING A VALVE BURIED BENEATH GROUND SURFACE, A METHOD FOR OPERATING A VALVE AND USE OF AN ACTUATOR SYSTEM

(71) Applicant: AVK Holding A/S, Galten (DK)

(72) Inventor: Søren KJÆR, Ry (DK)

(21) Appl. No.: 17/767,995

(22) PCT Filed: Sep. 16, 2020
(86) PCT No.: PCT/DK2020/050254

§ 371 Date: Apr. 11, 2022

(30) Foreign Application Priority Data
Oct. 10, 2019 (DK) PA 2019 70635

(51) Int. Cl. F16K 31/46; E03B 9/08; F16K 3/12

(52) U.S. Cl. CPC F16K 31/46; E03B 9/08; F16K 3/12

(57) ABSTRACT

An actuator system for actuating a valve buried beneath ground surface including a surface box having a bottom aperture into which operating means of an underlying valve can extend from beneath, and an electrical actuator arranged inside the surface box so that the surface box encloses the electrical actuator, where the electrical actuator comprises an operating part for engaging the operating means, fixation means for connecting the electrical actuator to the surface box, and drive means for rotating the operating part in relation to the fixation means.

### TECHNICAL FIELD

The disclosure relates to an actuator system for actuating a valve buried beneath ground surface. The actuator system comprises a surface box including a bottom aperture into which operating means of an underlying valve can extend from beneath. The disclosure also relates to a method for operating a valve buried beneath ground surface, wherein the valve comprises operating means configured so that a blocking element inside the valve moves between an open and a closed position in dependency of the direction in which the operating means is rotated. The disclosure further relates to use of an actuator system.

### BACKGROUND

Valves in e.g. a water distributing system are typically buried in the ground and operated manually from the ground surface. Thus, in a typical water distributing system it is a time and labor consuming task to operate the valves manually by means of a key even if the operating device of the valve is extended to substantially reach the ground surface.

From European patent no. EP 1 840 279 B1 it is therefore known to use a semi-automatic movable rotary device arranged to be moved around between different valves and mounted manually by an operator so that the device engages the valve through a surface box and can be operated by a rotational drive. However, this system is also time and labor consuming to operate.

The disclosure therefore provides for an advantageous technique for actuating a valve buried beneath ground surface.

### BRIEF SUMMARY

The disclosure provides for an actuator system for actuating a valve buried beneath ground surface. The actuator system comprises a surface box including a bottom aperture into which operating means of an underlying valve can extend from beneath, and an electrical actuator arranged inside the surface box so that the surface box encloses the electrical actuator. The electrical actuator comprises an operating part for engaging the operating means and fixation means for connecting the electrical actuator to the surface box. Furthermore, the electrical actuator comprises drive means for rotating the operating part in relation to the fixation means.

Locating the electrical actuator inside the surface box so that the surface box fully encloses the electrical actuator is advantageous in that the electrical actuator is hereby better protected against tampering, water, foreign objects and other by the more controlled environment inside the surface box.

And by rigidly connecting the electrical actuator to the surface box by means of the fixation means ensures that the torque generated by the electrical actuator during actuation of the operating means is supported by the surface box to ensure that the electrical actuator can apply sufficient torque to the operating means to enable that the operating means can be rotated, even if the operating means over time builds grater resistance against rotation over the full stroke of the valve.

It should be noted that in this context the term “operating means” includes any kind of operating device or operator of a valve by means of which a blocking element inside the valve can be displaced between an open and a closed position and vice versa when rotating the operating means. I.e. in this embodiment the term covers any kind of peg, pin, stud, handle, gear, wheel or other directly or indirectly connected to the mechanism inside the valve ensuring that the blocking element is displaced when the operating means is rotated.

It should also be noted that in this context the term “fixation means” includes any kind of fixator capable of rigidly connecting the electrical actuator to the surface box. I.e. the term comprises any kind of screws, bolts, rivets, adhesive, interlocking geometry, clamping device or other or any combination thereof.

Furthermore, it should be noted that in this context the term “drive means” includes any kind of driver, driving device or motor suitable for rotating the operating part of a valve in relation to the fixation means fixating the electrical actuator to the surface box.

In an aspect of the disclosure, the actuator system further comprises an actuator power unit for supplying electrical power to the electrical actuator.

The valves are often buried at remote locations where it would be difficult or expensive to provide a power connection to an external power source—such as the grid—and it is therefore advantageous to provide the actuator system with its own actuator power unit. Furthermore, an integrated actuator power unit enables a simpler installation of the actuator system.

It should be noted that in this context the term “power unit” includes any kind of power generator capable of generating and/or supplying electrical power. I.e. the term comprises any kind of battery, fuel cell, solar cell, generator driven by an internal combustion engine or other or any combination thereof.

In an aspect of the disclosure, the actuator power unit is arranged at or on the electrical actuator.

Placing the actuator power unit at or on the electrical actuator is advantageous in that the actuator power unit and the electrical actuator hereby can be formed as a single preassembled unit—thereby simplifying handling, storage and installation.

In an aspect of the disclosure, the actuator system further comprises external wireless communication means for communicating wirelessly with an external communication system.

E.g. in a water distributing system a large number of valves are scattered over a large area and it is therefore advantageous to provide the actuator system with external wireless communication means so that operation (e.g. opening and closing) of the valve by means of the actuator system may easily be initiated from a remote location by means of the external communication system. Furthermore, this also enables that actuator systems at several different valves may be operated wirelessly by the same external communication system and/or that one external communication system may collect data from many actuator systems installed at different locations.

It should be noted that in this context the term “external wireless communication means” includes any kind of external wireless communicator capable of wireless communication with any kind of external communication system. I.e. the term refers to any kind of data transmitter and/or data receiver capable of communicating by means of a wireless communication protocol such as WIFI, Sigfox, LoRa, Bluetooth, Zigbee or other.

In an aspect of the disclosure, the external wireless communication means is arranged in or on a lid of the surface box.

Most of the surface box is buried under the ground surface but to be able to access the inside of the surface box, the upper opening—provided with the lid—is freely accessible at the ground surface. It is therefore advantageous to place the external wireless communication means in or on the lid of the surface box to increase the communication range of the external wireless communication means. Furthermore, by placing the external wireless communication means in the lid, the actuator system may more easily be retrofitted in existing surface boxes simply by installing the actuator and replacing the lid.

In an aspect of the disclosure, the external wireless communication means comprises an antenna.

Making the external wireless communication means comprise an antenna it advantageous in that this will increase the communication range of the external wireless communication means both regarding transmitting and receiving.

In an aspect of the disclosure, the external wireless communication means comprises an external communication power unit for supplying electrical power to the external wireless communication means.

The valves are often buried at remote locations where it would be difficult or expensive to provide a power connection to an external power source—such as the grid—and it is therefore advantageous to provide the external wireless communication means with its own external communication power unit. Furthermore, an integrated external communication power unit enables a simpler installation of the external communication power unit.

In an aspect of the disclosure, the external communication power unit comprises one or more solar power cells.

Providing the external communication power unit with a solar power cell is advantageous in that wireless communication with an external central, device or other consumes relatively much power and if the external communication power unit is not provided with some sort of power generating device the external communication power unit will have to be able to store a large amount of electrical power. And this could be expensive and space consuming.

In an aspect of the disclosure, the actuator system further comprises internal communication means for communicating between the external wireless communication means and the electrical actuator.

The electrical actuator has to be arranged in the surface box on the operating means and as previously discussed it is advantageous to arrange the external wireless communication means so that communication with an external communication system is obstructed as little as possible—e.g. by placing it in the lid of the surface box. Thus, it is advantageous to provide the actuator system with internal communication means for communicating between the external wireless communication means and the electrical actuator.

It should be noted that the term “internal communication means” includes any kind of internal communicator capable of enabling communication between the external wireless communication means and the electrical actuator. I.e. the term refers to any kind of wired connection or any kind of wireless connection capable of transmitting and/or receiving data and/or signals by means of a wireless communication protocol such as Bluetooth, Zigbee, Near-field communication (NFC) or another wireless protocol or by means of visual, audial or tactile date communication devices such as audio signals, light signals running in optical fiber cable or other.

In an aspect of the disclosure, the surface box comprises one or more rotational impeders protruding from an outside surface of the surface box.

The torque transferred from the actuator to the surface box during rotation of the operating means can be quite significant and to prevent the surface box from rotating it is advantageous to provide the surface box with rotational impeders protruding from the outside surface of the surface box to better anchor the surface box in the surrounding ground.

In an aspect of the disclosure, the surface box comprises an upper opening arranged opposite the bottom aperture and wherein the upper opening is provided with a lid.

Providing the surface box with an upper opening enables easy access to the inside of the surface box and covering the upper opening with a lid is advantageous in that the lid will protect the inside of the surface box from unwanted access, water, foreign elements and other.

In an aspect of the disclosure, the actuator system further comprises at least one temperature sensor.

Providing the actuator system with a temperature sensor is advantageous in that it enables that the temperature of the actuator system can be monitored to e.g. compensate or prevent operation of the actuator in very high or low temperatures to achieve a more safe and precise operation. Furthermore, e.g. in relation to water distributing systems the valves—and thereby the surface boxes and actuator systems—are often located along existing infrastructure e.g. in or along the roads in a city. Thus, it is advantageous to also make the actuator system comprises a temperature sensor in that the distributed actuator systems hereby also could be used to monitor road temperatures and/or provide more precise local temperatures.

In an aspect of the disclosure, the actuator power unit and the external communication power unit are the same power unit.

Forming the actuator power unit and the external communication power unit as the same power unit is advantageous in that this will reduce cost and installation and simplify replacement.

In an aspect of the disclosure, the actuator system further comprises rotational angle detection means for detecting the rotational angle of the operating means.

Further providing the actuator system with rotational angle detection means is advantageous in that the operation of the actuator hereby can be controlled more precisely e.g. for stopping the actuator when an extreme position is reached, for reducing the speed of the actuator before an extreme position is reached or for communicating the actual open/close state of the valve at or on the actuator system or transmitting the state to a remote location.

It should be noted that in this context the term “rotational angle detection means” includes any kind of rotational angle detector capable of detecting how much the operating means is being rotated by the electrical actuator. I.e. the term includes any kind of rotary encoder system, potentiometer system, tachometer, magnets detected by sensors or other or any combination thereof.

It should also be noted that in this context the term “detecting the rotational angle of the operating means” includes that not only is the angular position detected but also that this done so that the number of rotations of the operating means is also detected. I.e. the term is not limited to only detecting angles between 0 and 360 degrees but includes continuous detecting angles between e.g. 0 and 2,000 degrees or another range depending on the number of rotations needed to move the blocking element of the valve between a fully closed or a fully open position or vice versa. And by continuously is not necessarily meant that all angular positions are detected accurately. The term also includes determining the rotation angle in increments e.g. with a resolution of 10 degrees, 45 degrees, 90 degrees, 180 degrees or even 360 degrees so that only every full rotation was detected.

In an aspect of the disclosure, the actuator system further comprises a memory for storing operational data.

Providing an actuator system with a memory which is capable of storing operational data is advantageous in that operational data hereby can be retrieved at any time and in that the operation of the actuator can be more precise or efficient if e.g. the operational data includes current position (i.e. weather the valve is open or closed), reference positions e.g. corresponding to open and closed, operational time to predict battery life or other.

In an aspect of the disclosure, the memory is arranged to also store identification data of the valve being actuated by the actuator system.

Storing identification data of the valve being actuated in the memory is advantageous in that by knowing the specific valve type the actuator system can operate more precise and/or efficiently. Furthermore, the identification data can be transmitted along with state data or other enabling more efficient communication with an external communication system or the external communication system can more efficiently control a large number of actuator systems by e.g. sending specific commands to only specific valve types.

In an aspect of the disclosure, the operating means comprises position detection means for directly or indirectly determining a position of a blocking element inside the valve.

Providing the operating means comprises position detection means for determining the position of the blocking element is advantageous this hereby can be done independent from the actuator system and thereby ensure more safe and precise operation.

It should be noted that in this context the term “position detection means” includes any kind of position detector capable of directly or indirectly determining the position of the blocking element inside the valve being actuated by the actuator system. I.e. the term includes any kind of processor capable of determining the position based on input from the actuator, from sensors, from stored information in a memory or other or any combination thereof and the term includes any kind of sensors capable of detecting the position directly or indirectly.

In an aspect of the disclosure, the actuator system comprises current level detection means for detecting a current level of the electrical actuator.

Providing the actuator system with current level detection means is advantageous in that it hereby is possible to stop the actuator if a current peak is detected—e.g. in case the blocking element collides with an unexpected object. Also, the detection of current peaks can act as a position detector in the actuator system in that the current of the drive means will be increased when the extreme positions of the blocking element has been reached.

It should be noted that in this context the term “current level detection means” includes any kind of current level detector capable of directly or indirectly detecting the current level of the electrical actuator. I.e. the term includes any kind of voltmeter, amperemeter, ohmmeter or other or any combination thereof.

In an aspect of the disclosure, the current level detection means comprises comparing means for detecting if current level exceeds a predefined level.

It is advantageous to make the current level detection means comprises comparing means in that it hereby is possible to control the operation of the actuator more precisely.

It should be noted that in this context the term “comparing means” includes any kind of current processor capable of directly or indirectly detecting if a current level detected by the current level detection means exceeds a predefined level. I.e. in this context the term includes any kind of computer, processer, logical circuit or other.

The disclosure also provides for a method for operating a valve buried beneath ground surface. The method comprises the steps of:
arranging a surface box at least partly in the ground at the ground surface so that operating means of the valve extend up into the surface box from beneath,
placing an electrical actuator inside the surface box,
arranging the electrical actuator so that it rigidly engages both the surface box and the operating means inside the surface box, and
rotating the operating means by means of the electrical actuator to operate the valve.

Operating a buried valve by means of an electrical actuator placed inside a surface box located at the ground surface above the valve is advantageous in that the valve hereby can be automatically actuated without having to unearth the valve and in a way that will ensure that the electrical actuator is well protected against the elements, tampering and other. Furthermore, operating the valve according to this method ensures that the electrical actuator is easily accessible for inspection, repair, replacement and other.

In an aspect of the disclosure, the method further comprises the step of placing external wireless communication means in or on the surface box.

Also placing external wireless communication means in or on the surface box is advantageous in that remote control of the actuator hereby is enabled and or remote monitoring of the actuator is enabled.

In an aspect of the disclosure, the method further comprises the step of transmitting an operation signal wirelessly to the external wireless communication means from an external communication system being external to the surface box to activate operation of the electrical actuator on the basis of the operation signal.

Valves are often buried at remote locations and it is therefore advantageous to be able to control them remotely.

In an aspect of the disclosure, the method comprises the step of securing the surface box against rotation in relation to the ground.

Ensuring that the surface box cannot rotate in relation to the ground in which it is arranged is advantageous in that the surface box hereby is capable of accepting the torque transferred to it when the actuator rotates the operating means.

In an aspect of the disclosure, the method comprises the step of arranging an extension device between the valve and the surface box to form part of the operating means.

Arranging an extension device between the valve and the surface box is advantageous in that the operating means hereby can be reached without having to make the surface box unnecessarily deep.

In an aspect of the disclosure, the method comprises the step of communicating position data regarding the blocking element from the external wireless communication means to the external communication system.

Communicating data regarding the position of the blocking element to a remote location is advantageous in that data regarding the open/closed state hereby can be monitored from a single central location.

In an aspect of the disclosure, the position data is communicated to the external communication system in response to a request send from the external communication system to the external wireless communication means.

Only communicating the position data when asked to do so is advantageous in that the power consumption of the external wireless communication means hereby can be reduced.

In an aspect of the disclosure, the valve comprises operating means configured so that a blocking element inside the valve moves between an open and a closed position in dependency of the direction in which the operating means is rotated. Hereby is achieved an advantageous embodiment of the disclosure.

In an aspect of the disclosure, the valve is operated by displacing the blocking element. Hereby is achieved an advantageous embodiment of the disclosure.

The disclosure further provides for a method according to any of the previously discussed methods, wherein the method is performed by means of any of the previously discussed actuator systems. Hereby is achieved an advantageous embodiment of the disclosure.

Even further, the disclosure provides for use of an actuator system according to any of the previously discussed actuator systems for actuating a valve buried beneath ground surface.

It is difficult and time consuming to retrofit an electrical actuator directly on a buried valve and even if the actuator was installed during installation of the buried valve the actuator would be very difficult to access subsequently in case of inspection, repair, replacement and other. Thus, it is advantageous to use an actuator system according to the present disclosure for actuating a valve buried beneath ground surface.

### BRIEF DESCRIPTION OF THE FIGURES

An embodiment of the disclosure will be described, by way of non-limiting example, in the following with reference to the figures in which:

FIG. 1 illustrates a partial cross section through the middle of a valve, as seen from the side,

FIG. 2 illustrates the valve of FIG. 1 with a cross section through the middle of an extension device, a surface box and an actuator system, as seen from the side,

FIG. 3 illustrates a cross section through the middle of an actuator system mounted in a surface box, as seen from the side, and

FIG. 4 illustrates an actuator system mounted in a surface box, as seen from the top.

### DETAILED DESCRIPTION

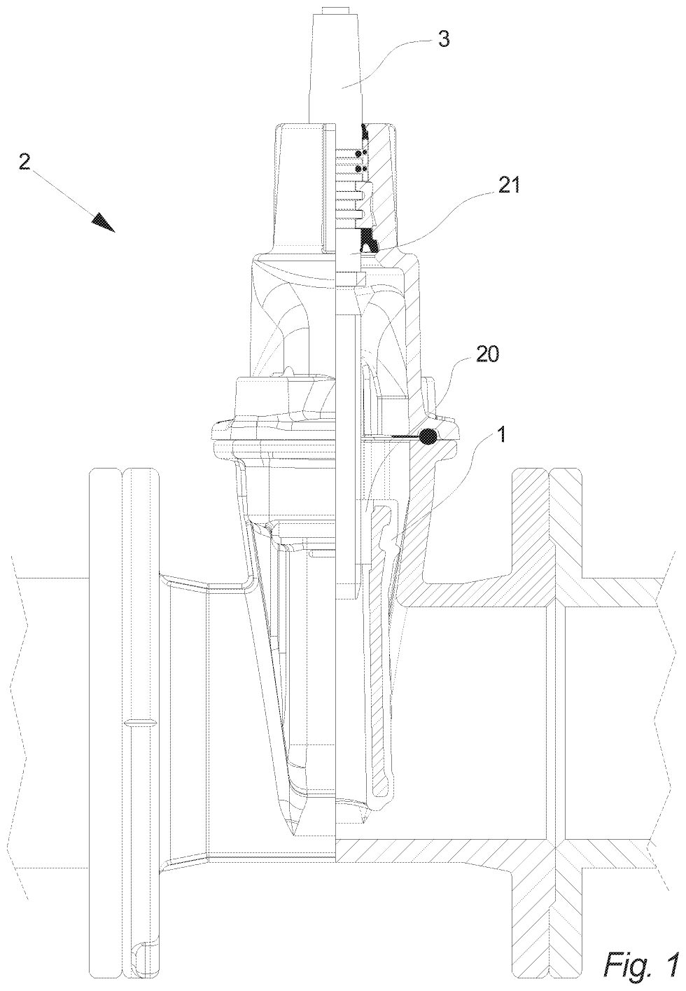

FIG. 1 illustrates a partial cross section through the middle of a valve 2, as seen from the side.

In this embodiment the valve 2 is a gate valve comprises a blocking element 1 in the form of a vertically displaceable wedge comprising a wedge nut 20. The valve 2 also comprises an operating means 3 located at the upper end of a substantially centrally arranged spindle 21, wherein the other end of the spindle 21 engages the wedge nut 20 through a helical spline thereby enabling that when the operating means 3 is mechanical manipulated—i.e. rotated—the spindle 21 will rotate and vertically displace the nut 32 and thereby the wedge 31 to raise or lower and thereby open or close the valve 2 to control the flow of a fluid through the valve 2.

However, in another embodiment the valve 2 could be another type of multi-turn valve where the spindle 21 and the operating means 3 will have to rotated more than one full rotation to move the blocking element 1 from an open position to a closed position—such as any kind of globe valve, fixed cone valve, needle valve, pinch valve or another type of valve 2 suited for controlling a flow of fluid through a pipe to which the valve 2 is connected—i.e. in another embodiment the blocking element 1 could comprise a plug, a disc, a needle, a hatch, a flexible sleeve, a pinching device or other. Or in another embodiment the valve 2 could in principle be a quarter-turn valve—i.e. a valve that only needs to be turned ninety degrees between fully open and fully closed positions, such as any kind of butterfly valves, ball valves, plug valve or other.

Also in another embodiment the operating means 3 could also or instead comprise a lever, a handle, a wheel or other and/or the operating means 3 could comprise another external shape and/or an internal shape suited for being engaged by a handle, a tool, a key or other so that the valve 2 may be manipulated in order to actuate the blocking element 1 in the valve 2.

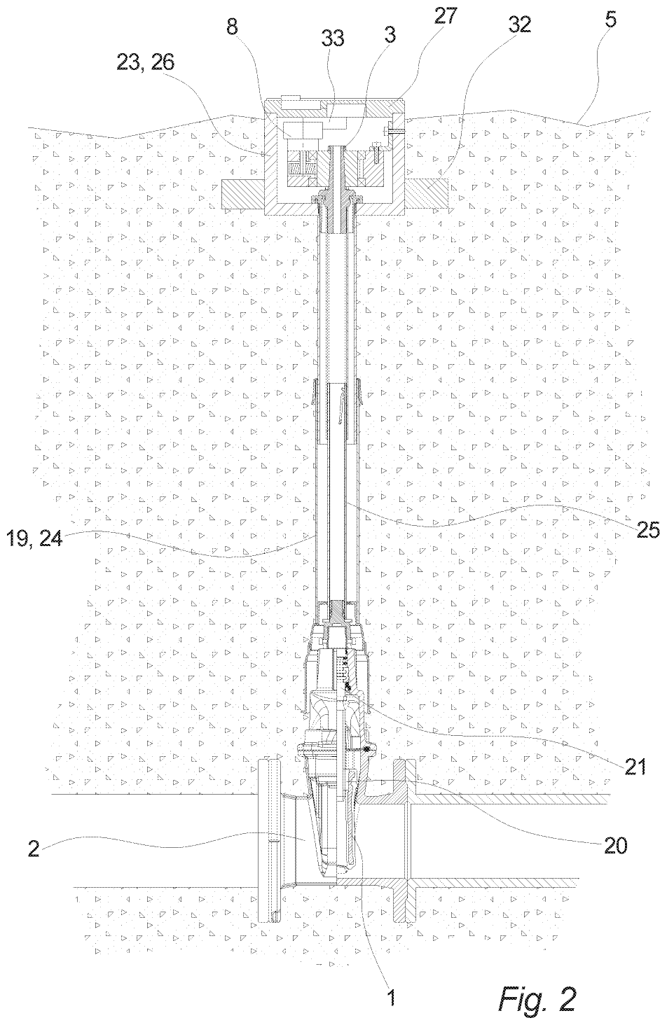

FIG. 2 illustrates the valve of FIG. 1 with a cross section through the middle of an extension device 19, a surface box 23 and an actuator system 4, as seen from the side.

In this embodiment the operating means 3 of a buried valve 2 comprises an extension device 19 formed by an extension device housing 24 substantially surrounding an inner extension rod 25. At ground surface the extension rod 25 of the extension device 19 extends up into a surface box 23 to enable that the operating means 3 —comprising the extension device 19—may easily be accessed and manipulated at ground level. However, in another embodiment the extension device 19 could be formed in numerous other ways such as a simple extension rod, it could also or instead comprise gears to displace the rotational axis or to gear the rotation of the operating means 3, it could also or instead comprise brakes or couplings, it could also or instead comprise joints such as an universal joint or other. Also, in another embodiment the operating means 3 would not comprise an extension device 19 and the surface box 23 would then be located immediately above the valve 2.

In this embodiment the surface box 23 comprises a surface box housing 26 having a bottom aperture 7 at the bottom through which the operating means 3 extends up into the surface box housing 26. In this embodiment the surface box 23 is cylindrical but in another embodiment, it could be square, triangular or have a different shape.

In this embodiment the surface box housing 26 is placed in the ground so that the top of the surface box 23 is substantially level with the ground surface. However, in another embodiment the surface box 23 could be arranged deeper in the ground or it could be placed more or less on or over ground level.

In this embodiment the surface box housing 26 also has an upper opening 33 arranged at the top of the surface box housing 26 opposite the bottom aperture 7. The upper opening 33 enables access to the inside of the surface box 23.

In this embodiment the surface box 23 further comprises a lid 27 arranged to cover said upper opening 33 and thereby protect the inside of the surface box 23 from unwanted access, water, foreign elements and other.

In this embodiment the actuator system 4 comprises an electrical actuator 8 arranged on the operating means 3 inside the surface box 23 so that the electrical actuator 8 is fully enclosed by the surface box 23. However in another embodiment at least parts of the electrical actuator 8 could be arranged to extend into or even through the walls or the lid 27 of the surface box 23.

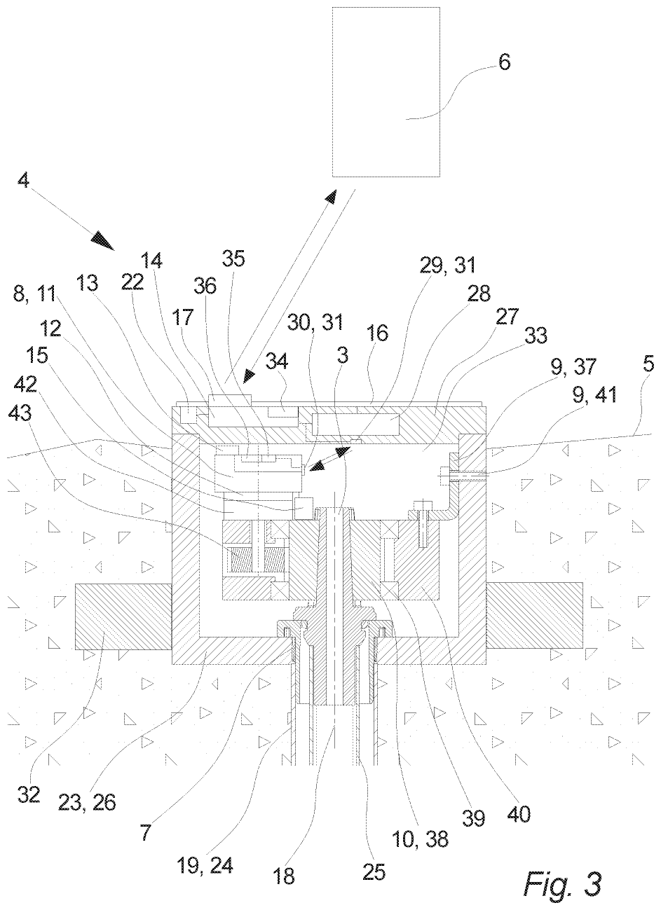

FIG. 3 illustrates a cross section through the middle of an actuator system 4 mounted in a surface box 23, as seen from the side.

In this embodiment the electrical actuator 8 comprises an operating part 10 in the form of an operating gear 38 for engaging the operating means 3. In this embodiment the operating part 10 engages the operating means 3 by having a center hole formed to fit tightly onto the star shaped operating means 3 so that the operating part 10 is capable of rotating the operating means 3. I.e. in this embodiment the operating part 10 is directly connected to the operating means 3 but in another embodiment the operating part 10 could be indirectly connected to the operating means 3 through a gearing, a bracket, a fixture or other or the operating part 10 could be directly connected to the operating means 3 through another type of engagement means such as bolts, a clamping device, adhesive or other allowing the operating part 10 to rotate the operating means 3.

In this embodiment the electrical actuator 8 also comprises drive means 11 in the form of an electrical motor arranged to drive the operating part 10 through a drive gear 43 meshing with external teeth on the operating gear 38. The drive means 11 is in this embodiment mounted on an actuator support 40 encircling the operating part 10 and rotatably supporting the operating part 10 through two bearings 39. In this embodiment the electrical actuator 8 comprise fixation means 9 in the form of fixation brackets 37 and bolt connections 41 connecting electrical actuator 8 to the inside wall of surface box housing 26 but in another embodiment the fixation means 9 could also or instead comprise a clamping device, a wedging arrangement, interlocking geometry or other ensuring that the electrical actuator 8 is connected to the surface box 23 so that they are rigidly fixed against mutual rotation.

In this embodiment the drive means 11 is connected to the drive gear 43 through a gearbox 42 and the drive means 11 is provided with rotational angle detection means 12 in the form of a rotary encoder. The rotational angle detection means 12 will detect the rotation angle of the drive means 11 and thereby detect the number of rotations. However, in another embodiment rotary encoder 12 could be located elsewhere such as after or in the gearbox, in the drive means 11, on the operating means 3 or other and/or the rotational angle detection means 12 could also or instead comprise one or more Hall Effect sensors detecting one or more magnets, it could comprise a potentiometer device, a tacho device or other. Also, in another embodiment the electrical actuator 8 would not comprise a gearbox 42 and/or rotational angle detection means 12.

In this embodiment the actuator system 4 also comprises position detection means 13 capable of detecting the position of the blocking element 1 in the underlying valve 2 based on input from the rotational angle detection means 12. I.e. in this embodiment the position detection means 13 can calculate that if the rotational angle detection means 12 has detected a certain angular movement, the blocking element 1 will have moved from open to closed position or vice versa. However, in another embodiment the position detection means 13 would also comprise a memory of at least have access to a memory for storing information regarding extreme positions of the blocking element 1 and/or it would also receive input from limit switches, a current level detector or other providing additional information on which the position detection means 13 may more accurately calculate or detect the actual position of the blocking element 1. In this embodiment the position detection means 13 comprises a processor for deducing the position of the blocking element 1 but in another embodiment the position detection means 13 could also or instead comprise any kind of microprocessor, logical circuit, programmable or hardwired logic controller, data processing system or other or any combination thereof. And in another embodiment the position detection means 13 could also or instead be located elsewhere on the actuator system 4—such as integrated with the motor controller, on the actuator support 40, in or on the lid or other.

In this embodiment the electrical actuator 8 comprises an actuator power unit 15 in the form of a battery for providing electrical power to the drive means 11. In this embodiment the actuator power unit 15 is placed on top of the drive means 11 so that it is easy to access in case of replacement or charging but in another embodiment the actuator power unit 15 could be placed elsewhere at or on the electrical actuator 8 or the actuator power unit 15 could be placed elsewhere at or on the surface box 23 —such as in or on the lid 27 and then by connected to the drive means 11 through an electrical conductor.

In this embodiment the electrical actuator 8 also comprises current level detection means 35 in the form of an ammeter detecting the current through the drive means 11. The electrical actuator 8 also comprises comparing means 36 arranged to compare the current detected by the current level detection means 35 with a predefined threshold. I.e. if the blocking element 1 collides with a foreign object, if the position detection means 13 malfunctions, if an extreme position sensor (not shown) malfunctions or other, the comparing means 36 will detect that the output from the current level means 35 is above the predefined level and the drive means 11 can be instructed to stop. The current level detection means 35 and comparing means 36 can also be used as position detection means 13 in that when the detected current level rises above a predefined level this will—along with information regarding the direction of travel—mean that the blocking element 1 has reached a fully open or fully closed position.

In this embodiment the electrical actuator 8 is basically a motor 11 driving the operating means 3 through a toothed gearing but the skilled person would know that the electrical actuator 8 could be designed in numerous other ways e.g. also or instead comprising a direct drive motor, comprising more motors, comprising belt or chain drives, comprising clutches, brakes, couplings, comprising a different gearbox or no gearing or other or any combination thereof by which the drive means 11 can rotate an operating part 10 and thereby the operating means 3 in relation to the fixation means 9.

In this embodiment external wireless communication means 14, a memory 34, an external communication power unit 28, an antenna 17 and a temperature sensor 22 are all integrated with the lid 27 of the surface box 23. However, in another embodiment fewer or more components of the actuator system 4 could be placed in or on the lid 27, some of the components of the actuator system 4 could also or instead be placed in or on the surface box housing 26 and/or on, in or at another surface or object close to the operating means 3 or all the components of the actuator system 4 could be formed as a single interconnected unit.

In this embodiment the actuator system 4 comprises external wireless communication means 14 for communicating wirelessly with an external communication system 6. In this embodiment external wireless communication means 14 comprises both a wireless transmitter and a wireless receiver so that the external wireless communication means 14 is capable of both receiving from and transmitting to the external communication system 6. However, in another embodiment the external wireless communication means 14 would only comprise a wireless receiver.

In this embodiment the external communication system 6 is a communication central at a water distributing plant capable of transmitting signals and data and receiving signals and data from many actuator systems 4 installed in the water distributing system to enable remote control of the distribution of the water. However, in another embodiment the external communication system 6 could also or instead comprise a local communication system, a mobile phone, a cloud storage or control system, a mobile communication system 6, a dedicated remote controller or other or any combination thereof.

In this embodiment the external wireless communication means 14 comprises an antenna 17 located on top of the lid 27 of the surface box 23 to ensure free and unobstructed wireless communication but in another embodiment the antenna 17 could be integrated in the lid 27, integrated in the surface box housing 26, integrated with the external wireless communication means 14, it could be located elsewhere in, on or outside the surface box 23 or other or any combination thereof.

In this embodiment the external wireless communication means 14 is arranged to communicate wirelessly with the external communication system 6 via the Sigfox protocol but in another embodiment the external wireless communication means 14 would also or instead comprise other means for long range wireless communication via e.g. WIFI, LoRa or other protocols or the external wireless communication means 14 would also or instead comprise means for short range wireless communication via e.g. Bluetooth, Zigbee, NFC or other protocols. In another embodiment of the disclosure the actuator system 4 would further comprise a relay unit or a repeater unit for receiving data from to one or more other actuator systems 4 and repeating it on to another actuator system 4, to a central unit, to a concentrator or other.

In this embodiment external wireless communication means 14 also comprises a dedicated external communication power unit 28 in the form of a battery for supplying electrical power to the external wireless communication means 14. In this embodiment the external communication power unit 28 is also placed in the lid 27 but in another embodiment the external communication power unit 28 could be placed elsewhere in, in or at the surface box 23 and/or the external communication power unit 28 could be formed integrally with the actuator power unit 15 as a single power unit.

In this embodiment the external communication power unit 28 also comprises a solar power cell 16 connected to the external communication power unit 28 in the lid 27 to provide power to the power unit 28. However, in another embodiment the actuator system 4 could also or instead be provided with a fuel cell, a generator or other means for providing electrical power to the electrical power consuming components of the actuator system 4. In another embodiment the actuator system 4 could also or instead be connected an external electrical power supply such as the electrical grid.

When at least some of the components of the actuator system 4 are placed on or at the operating means 3 and some of the components of the actuator system 4 are placed at another nearby location—e.g. in and on the lid 27 as disclose in FIG. 3 —components at the two locations will have to communicate. In this embodiment this is done wirelessly by means of the first internal communicator 29 arranged on the lid 27 communicating wirelessly with the second internal communicator 30 arranged on the sensor bracket 28 to enable that the lid 27 may easily be removed from the surface box 23 because no wires are connecting the two parts of the actuator system 4. However, in another embodiment this communication could also or instead take place by means of a wired connection.

In this embodiment the first internal communicator 29 and the second internal communicator 30 communicates wirelessly with each other through Bluetooth but in another embodiment the wireless communication could take place by means of Near-field communication (NFC), Zigbee, WIFI or another wireless protocol.

In this embodiment the actuator system 4 further comprises a temperature sensor 22 arranged in the lid 27 of the surface box 23. I.e. in this embodiment the actuator system 4 can also detect and communicate the ground surface temperature. However, in another embodiment a temperature sensor 22 could also or instead be placed on the actuator support 40 or elsewhere in, on or at the surface box 23. In another embodiment the actuator system 4 could also or instead comprise other sensors like rain sensors, moist sensors, smog sensors, tamper sensors, light sensors, a microphone, a pressure sensor, an accelerometer or other kinds of sensors or a GPS unit or other enabling that additional information could advantageously be provided by the actuator system 4 given that the actuator systems can be distributed advantageously in relation to e.g. get a good and well distributed data overview.

In this embodiment the surface box 23 also comprises rotational impeders 32 in the form of two plates protruding outwards from an outside surface of the surface box 23 to prevent the surface box 23 from rotating when the torque from the actuator 8 is transferred to the surface box 23. However, in another embodiment the rotational impeders 32 could also or instead comprise protruding pins, rods, discs or other and/or the outside surface of the surface box 23 could be formed irregularly with ribs, dimples, grooves or other and/or the rotational impeders 32 could be enabled through the geometry of the surface box e.g. if at least a part of the horizontal cross section of the surface box 23 was triangular, square, rectangular or other.

In this embodiment the actuator system 4 further comprises a memory 34 for storing operational data such as current position of blocking element 1, position of the surface box 23, identification data of the valve 2 being actuated by the actuator system 4 or other or for logging operational data for later transmission or internal use. In this embodiment the memory 34 is integrated with the external wireless communication means 14 but in another embodiment the memory 34 could be located elsewhere in, on or at the surface box 23.

In this embodiment the actuator system 4 is also arranged to receive an activation signal which will active the actuator system 4. During storage, handling, mounting etc. internal power from the actuator power unit 15 and/or the external communication power unit 28 to at least some of the other components of the actuator system 4 is cut off to save power so that e.g. only the memory 34 and at least parts of the external wireless communication means 14 will be powered. In response to receiving an activation signal, the actuator system 4 will enable full power to all parts of the actuator system 4—when needed—and the actuator system 4 will be in full operating mode.

However, in another embodiment more, less or other components could be without power until the activation signal is provided and/or the system 4 could comprise more than one activation state so that the activation signal would enable the actuator system 4 would enter normal operation mode but a power saving signal would enable the actuator system 4 would enter power saving mode. Also, in another embodiment a close down signal would enable a full shut down of the system 4 or other signal and modes could be included.

In this embodiment the activation signal is received wirelessly from the external communication device 6 but in another embodiment the activation signal could be received through a wired arrangement, through the push of a button on the actuator system 4, through a user interface integrated in the actuator system 4, through a remote control or another way. Or in another embodiment the actuator system 4 would be always on or the actuator system 4 would be activated by connecting the power unit or units 15, 28 to the actuator system 4.

In this embodiment the valve 2 is operated by arranging the surface box 23 at least partly in the ground at the ground surface 5 so that operating means 3 extend up into the surface box from beneath. The electrical actuator 8 is then placed inside the surface box 23 so that it rigidly engages both the surface box 23 and the operating means 3 inside the surface box 23 as discussed in the above to allow the operating means 3 to be rotated by means of the electrical actuator 8 to displace the blocking element 1 in the valve 2.

In this embodiment the electrical actuator 8 is capable of autonomous operation but in another embodiment the method of operating the valve 2 would also include placing external wireless communication means 14 in or on the surface box 23 and transmitting an operation signal wirelessly to the external wireless communication means 14 from an external communication system 6 to activate operation of said electrical actuator 8 and/or to control the operation of the electrical actuator 8 and/or communicating position data regarding the blocking element 1 to the external communication system 6. The communication from the external wireless communication means 14 is in this embodiment only done in response to a request send from the external communication system 6 but in another embodiment signals and/or data could also or instead be transmitted to the external communication system 6 at regular time intervals, in response to specific events, in response to input through an interface or button or other.

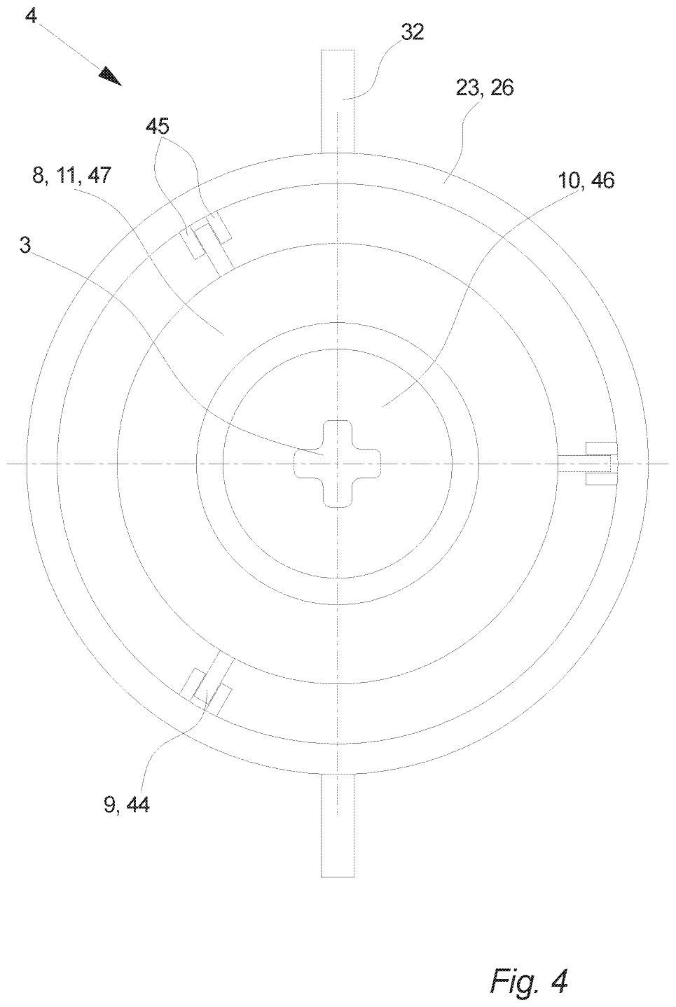

FIG. 4 illustrates an actuator system 4 mounted in a surface box 23, as seen from the top.

In this embodiment the actuator system 4 comprises an electrical actuator 8 in the form of a direct drive motor where operating part—i.e. the rotor part 46 of the direct drive motor—is rigidly connected to the operating means 3 and the stator part 47 is rigidly connected to the inner wall of the surface box 23 by means of fixation means 9 in the form of protruding arms 32 arranged to engage protruding walls 33 of the surface box housing 24 so that the stator part 47 is fixed against rotation in relation to the operating means 3.

The disclosure has been exemplified above with reference to specific examples of valves 2, blocking elements 1, actuator systems 4 and other. However, it should be understood that the disclosure is not limited to the particular examples described above but may be designed and altered in a multitude of varieties within the scope of the disclosure as specified in the claims.

1. An actuator system for actuating a valve buried beneath ground surface, said actuator system comprising
a surface box comprising a bottom aperture into which operating means of an underlying valve can extend from beneath, and
an electrical actuator arranged inside said surface box so that said surface box encloses said electrical actuator, wherein said electrical actuator comprises an operating part for engaging said operating means, wherein said electrical actuator comprise fixation means for connecting said electrical actuator to said surface box and wherein said electrical actuator comprises drive means for rotating said operating part in relation to said fixation means.

2. An actuator system according to claim 1, wherein said actuator system further comprises an actuator power unit for supplying electrical power to said electrical actuator.

3. An actuator system according to claim 2, wherein said actuator power unit is arranged at or on said electrical actuator.

4. An actuator system according to claim 1, wherein said actuator system further comprises external wireless communication means for communicating wirelessly with an external communication system.

5. An actuator system according to claim 4, wherein said external wireless communication means is arranged in or on a lid of said surface box.

6. An actuator system according to claim 4, wherein said external wireless communication means comprises an antenna.

7. An actuator system according to claim 4, wherein said external wireless communication means comprises an external communication power unit for supplying electrical power to said external wireless communication means.

8. An actuator system according to claim 7, wherein said external communication power unit comprises one or more solar power cells.

9. An actuator system according to claim 4, wherein said actuator system further comprises internal communication means for communicating between said external wireless communication means and said electrical actuator.

10. An actuator system according to claim 1, wherein said surface box comprises one or more rotational impeders protruding from an outside surface of said surface box.

11. An actuator system according to claim 1, wherein said surface box comprises an upper opening arranged opposite said bottom aperture and wherein said upper opening is provided with a lid.

12. An actuator system according to claim 1, wherein said actuator system further comprises at least one temperature sensor.

13. An actuator system according to claim 2, wherein said actuator power unit and said external communication power unit are the same power unit.

14. An actuator system according to claim 1, wherein said actuator system further comprises rotational angle detection means for detecting the rotational angle of said operating means.

15. An actuator system according to claim 1, wherein said actuator system further comprises a memory for storing operational data.

16. An actuator system according to claim 15, wherein said memory is arranged to also store identification data of said valve being actuated by said actuator system.

17. An actuator system according to claim 1, wherein said actuator system comprises current level detection means for detecting a current level of said electrical actuator.

18. An actuator system according to claim 17, wherein said current level detection means comprises comparing means for detecting if said current level exceeds a predefined level.

19. A method for operating a valve buried beneath ground surface, said method comprising the steps of:
arranging a surface box at least partly in the ground at said ground surface so that operating means of said valve extend up into said surface box from beneath,
placing an electrical actuator inside said surface box,
arranging said electrical actuator so that it rigidly engages both said surface box and said operating means inside said surface box, and
rotating said operating means by means of said electrical actuator to operate said valve.

20. A method according to claim 19, wherein said method further comprises the step of placing external wireless communication means in or on said surface box.

21. A method according to claim 20, wherein said method further comprises the step of transmitting an operation signal wirelessly to said external wireless communication means from an external communication system being external to said surface box to activate operation of said electrical actuator on the basis of said operation signal.

22. A method according to claim 19, wherein said method comprises the step of securing said surface box against rotation in relation to said ground.

23. A method according to claim 19, wherein said method comprises the step of arranging an extension device between said valve and said surface box to form part of said operating means.

24. A method according to claim 19, wherein said method comprises the step of communicating position data regarding said blocking element from said external wireless communication means to said external communication system.

25. A method according to claim 24, wherein said position data is communicated to said external communication system in response to a request send from said external communication system to said external wireless communication means.

26. A method according to claim 19, wherein said valve comprises operating means configured so that a blocking element inside said valve moves between an open and a closed position in dependency of the direction in which said operating means is rotated.

27. A method according to claim 26, wherein said valve is operated by displacing said blocking element.

28. A method according to claim 19, wherein said method is performed by means of an actuator system comprising:
a surface box comprising a bottom aperture into which operating means of an underlying valve can extend from beneath, and
an electrical actuator arranged inside said surface box so that said surface box encloses said electrical actuator, wherein said electrical actuator comprises an operating part for engaging said operating means, wherein said electrical actuator comprise fixation means for connecting said electrical actuator to said surface box and wherein said electrical actuator comprises drive means for rotating said operating part in relation to said fixation means.

29. An actuator system according to claim 1, configured for actuating a valve buried beneath ground surface.
